(19) United States
(12) Patent Application Publication
(10) Pub. No.: US 2009/0319755 A1
(43) Pub. Date: Dec. 24, 2009

(54) Method and Apparatus for High Speed Data Stream Splitter on an Array of Processors

(75) Inventor: Michael B. Montvelishsky, Burlingame, CA (US)

Correspondence Address: HENNEMAN & ASSOCIATES, PLC, 70 N. MAIN ST., THREE RIVERS, MI, 49093, US

(73) Assignee: VNS PORTFOLIO LLC, Cupertino, CA (US)

(21) Appl. No.: 12/417,409

(22) Filed: Apr. 2, 2009

Related U.S. Application Data
(60) Provisional application No. 61/074,097, filed on Jun. 19, 2008.
(60) Provisional application No. 61/094,501, filed on Sep. 5, 2008.

(51) Int. Cl. G06F 15/80; G06F 9/06

(52) U.S. Cl. 712/17; 712/E09.003

(57) ABSTRACT

A method and apparatus for processing a stream of data. The apparatus includes an array of processors connected to one another by single drop busses. The data stream is inputed to one of the processors 305(da), which splits off a substream and passes the data stream onto a second processor 305(db), which repeats the process; this continues until all of the data stream has been split into substreams. Each substream is processed in parallel by a second grouping 315 of processors. This second group of processors may have multiple steps and processors 315, 320. The processed substreams are assembled into a single data stream 330 by a third group of processors 325 reversing the splitting process and outputted from the array by a last processor 305(ae).

### CROSS-REFERENCE TO RELATED APPLICATIONS

This application claims the benefit of U.S. Provisional Patent Application Ser. No. 61/094,501 entitled “High Speed Data Stream Splitter”, filed on Sep. 5, 2008; and U.S. Provisional Patent Application Ser. No. 61/074,097 entitled “High Speed Data Stream Splitter”, filed on Jun. 19, 2008, which are incorporated herein by reference in their entirety.

### COPYRIGHT NOTICE AND PERMISSION

A portion of the disclosure of this patent document contains material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD OF THE INVENTION

The present invention pertains to data processing. In particular, the invention pertains to processing intensive function at high speed. With greater particularity, the invention pertains to methods and apparatus for dividing processing tasks in an efficient manner for rapid processing. With still greater particularity, the invention pertains to methods and apparatus of implementing high-speed data stream splitting, computation, and data on an array of processors.

### BACKGROUND OF THE INVENTION

Processing devices can be utilized for a wide range of applications, including the data processing of large amounts of data. In conventional systems, a stream of serial data is processed one data sample at a time by a single processing device. For example, a first data sample is processed, then a second, then a third, and so on until all samples are processed by the same processing device. The use of multiple processing devices will only speed up the processing of data so long as there is a common bus between the processing devices that controls the input and output of the stream to and from the processing devices.

A problem has arisen when such arrays are used for rapid processing of real time information common in audio, video and signal processing applications. The incoming data stream information must be rapidly processed in order to be useful. This requires division of processing tasks and transmission to multiple processors. This division process becomes a bottleneck, limiting speed to that of the division process. Accordingly, there is a need for a method and apparatus for rapidly splitting, processing, and reformulation of a high speed data stream.

### SUMMARY OF THE INVENTION

The proposed invention uses computers on an array of processors for the purpose of high speed data stream splitting, processing, and reformulation. An array of processing devices can also be used to perform the task of separating a data stream, processing the data, and reformulating the processed data. An array of multiple processing devices can be utilized to divide each of the larger tasks into smaller subtasks spread across the array. The smaller tasks are performed simultaneously, thus improving the performance of the larger task. In addition, the same smaller task can be divided in a way that many processing devices are performing the same task, and thus improving the overall speed of the large task.

One scenario of doing this is to input a data stream into a group of processors connected in serial. As the data stream passes individual processors substreams are split off at the processors. Each substream is then processed separately in a second group of processors. This second group of processors may have multiple steps and multiple processors for each substream. Finally, a third group of processors assembles the substreams into a processed data stream. This third group of processors may be connected in serial to form a virtual mirror image of the first group of processors.

The invention provides an efficient fast method of processing a data stream by means of a processor array.

### BRIEF DESCRIPTION OF THE FIGURES

FIG. 1 is a flow chart of a first embodiment of the method of the invention.

FIG. 2 is a block diagram of a first embodiment of the apparatus of the invention.

FIG. 3 is a block diagram of a second embodiment of the apparatus of the invention.

FIG. 4a is a printout of example machine language and compiler directives to instruct a processing device in FIG. 2 embodiment of the invention.

FIG. 4b is a second printout of example machine language and compiler directives to instruct a second processing device in FIG. 2 embodiment of the invention.

FIG. 4c is a third printout of example machine language and compiler directives to instruct a third processing device in FIG. 2 embodiment of the invention.

### DETAILED DESCRIPTION OF THE INVENTION

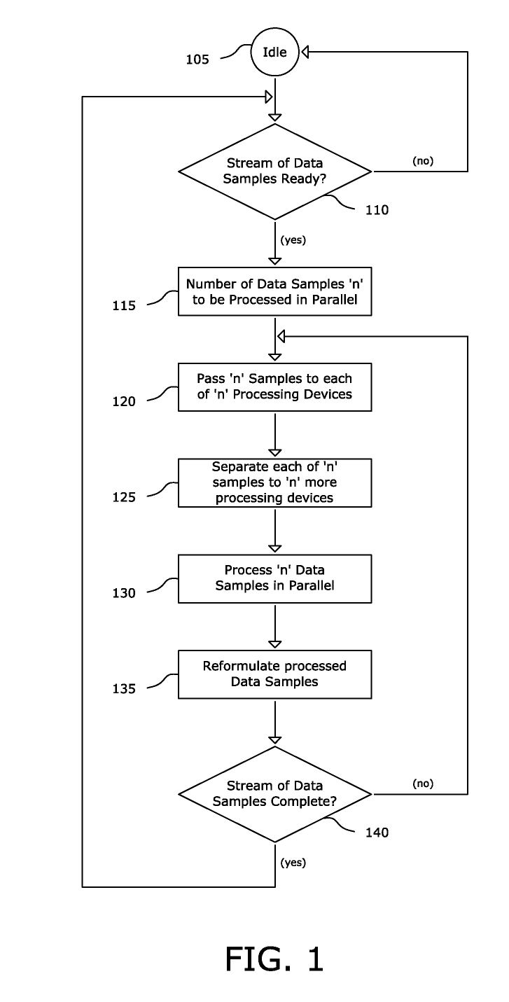

FIG. 1 is a flow chart of a first embodiment of the method of the invention. This embodiment controls a high speed data stream split, process, and reformulation. In the power up condition the state machine is in an idle state 105. In a step 110, the state machine verifies if a stream of data samples is ready for processing on an array of processing devices. If the stream of data samples is ready for processing, then in a step 115 the number of data samples to be processed in parallel ‘n’ is determined based on the information from the stream of data samples and the number of available processing devices. Otherwise, the state machine returns to the idle state 105. In a step 120, ‘n’ samples are passed to each of the ‘n’ processing devices. In a step 125, ‘n’ more processing devices are used to separate the first sample, second sample . . . up until the nt sample. In a step 130, ‘n’ more processing devices are used to process in parallel the first of the ‘n’ samples, second of the ‘n’ samples . . . up until the n^{th} of the ‘n’ samples. In a step 135, ‘n’ more processing devices are used to reformulate the ‘n’ processed samples. In a step 140, the completion of the processed stream of data values is verified. If all data in the stream has been split, processed, and reformulated in the step 140, then the state machine returns to an idle state 105. Otherwise, the state machine returns to sending the next ‘n’ samples to the ‘n’ processing devices in a step 120. The use of the “n” designation is arbitrary, the invention is not limited to any specific number of processors and the Figures are given as examples only, the invention being limited by the claims only.

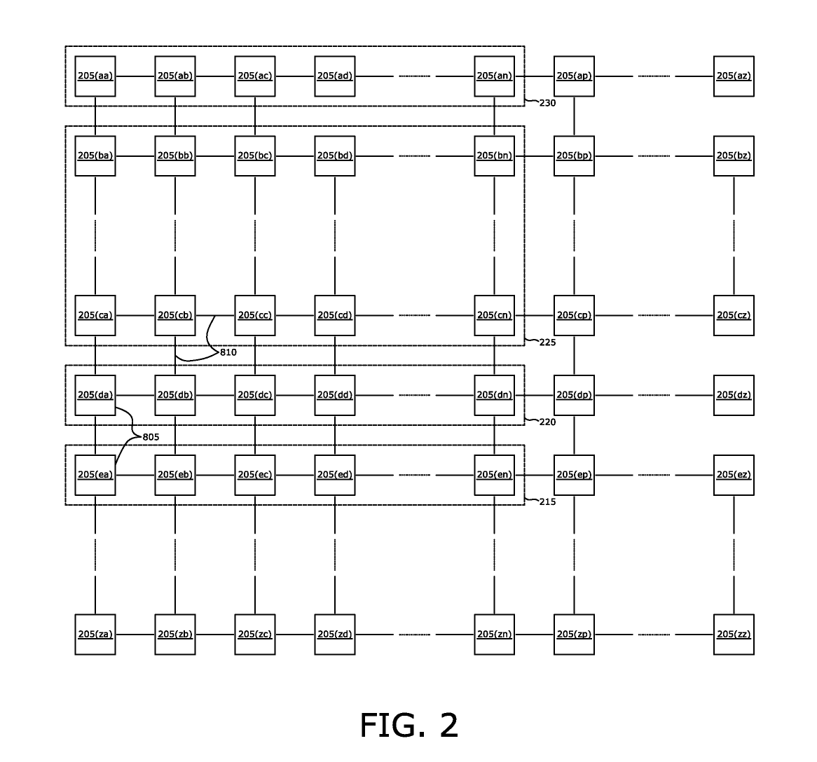

FIG. 2 is an array of processing devices for performing high speed data stream split, processing, and reformulation according to one embodiment. A processing device 205 communicates with a neighboring processing device over a single drop bus 210 that includes data lines, read lines, read control lines, and write control lines. There is no common bus. For example, processing device 205(db) communicates with four neighboring processing devices 205(da), 205(cb), 205(dc), and 205(eb) using buses 210. In an alternate embodiment, a diagonal intercommunication bus (not shown) is used to communicate diagonally with neighboring processing devices in addition or instead of the present buses 110. For example, processing device 205(db) would communicate with neighboring processors 205(ca), 205(cc), 205(ec), and 205(ea).

Also shown in FIG. 2 are four groupings of processing devices. A first grouping of processing devices 215 performs the function of sending each of the ‘n’ samples to each of the ‘n’ processing devices. Thus, each of the processing devices 205(ea)-205(en) receive all ‘n’ data samples and pass all ‘n’ data samples to processing devices 205(da)-205(dn). A second grouping of processing devices 220 performs the function of separating the ‘n’ samples such that processing device 205(da) sends the first of the ‘n’ samples to processing device 205(ca), processing device 205(cb) sends the second of the ‘n’ samples to processing device 205(bb), processing device 205(dc) sends the third of the ‘n’ samples to processing device 205(cc), and so on and so forth until processing device 205(dn) sends the n^{th} of the ‘n’ samples to processing device 205(cn).

In an alternate embodiment, processing device 205(da) sends the n^{th} of the ‘n’ samples to processing device 205(ca), processing device 205(db) sends the (n-1)^{th} of the ‘n’ samples to processing device 205(da), and so on and so forth until processing device 205(dn) sends the first of the ‘n’ samples to processing device 205(cn).

In a second alternate embodiment, the ‘n’ data values present in each of the processing devices 205(da)-205(dn) are sent to processing devices 205(ca)-205(cn) in such a way that each of the processing devices 205(ca)-205(cn) only receive one of the ‘n’ data values and that no single data value is left out, which also implies that no two processing 205(ca)-205(cn) devices receive a duplicate data value. The difference between this embodiment and the previous two embodiments is that the row of processing devices 205(ca)-205(cn) do not receive data values based on an ascending or descending order with respect to the data stream order.

A third grouping of processing devices 225 performs the function of signal processing. A column of processing devices within grouping 225 is used to process each data sample in parallel. Each of the processing devices 205(ca)-205(cn) receives a single data value from processing devices 205(da)-205(dn). Each row of processing devices, as part of grouping 225, must perform an identical function. Hence, the number of processing devices in each column is arbitrary.

A fourth grouping of processing devices 230 performs the function of reformulating the processed data. The processed data value in processing device 205(ba) is sent to processing device 205(aa), and the processed data value in processing device 205(bb) is sent to processing device 205(ab), and so on and so forth until the processed data value in processing device 205(bn) is sent to processing device 205(an).

Recall that in one embodiment, processing device 205(aa) contains the first of ‘n’ processed data, processing device 205(ab) contains the second of ‘n’ processed data, and so on and so forth so that processing device 205(an) contains the nt of ‘n’ processed data. Hence, to reformulate the data stream in the same order it was received into the processing device involves passing the data values in each of the processing devices 205(aa)-205(an) in the direction of processing device 205(aa).

Recall that in an alternate embodiment, processing device 205(aa) contains the n^{th} of ‘n’ processed data, processing device 205(ab) contains the (n-1)^{th} of ‘n’ processed data. Hence, to reformulate the data stream in the same order it was received into the processing device involves passing the data values in each of the processing devices 205(aa)-205(an) in the direction of processing device 205(an).

Recall that in a second alternate embodiment, prior to the processing of the data in grouping 225 and in grouping 220, the data is separated such that processing devices 205(ca)-205(cn) receive only one unique data value of the ‘n’ data values and that the row of processing devices 205(ca)-205(cn) do not receive data values based on an ascending or descending order with respect to the data stream order. Hence, to reformulate the data stream in the same order in which it was received involves more than just a movement of the data in the direction of a processing device.

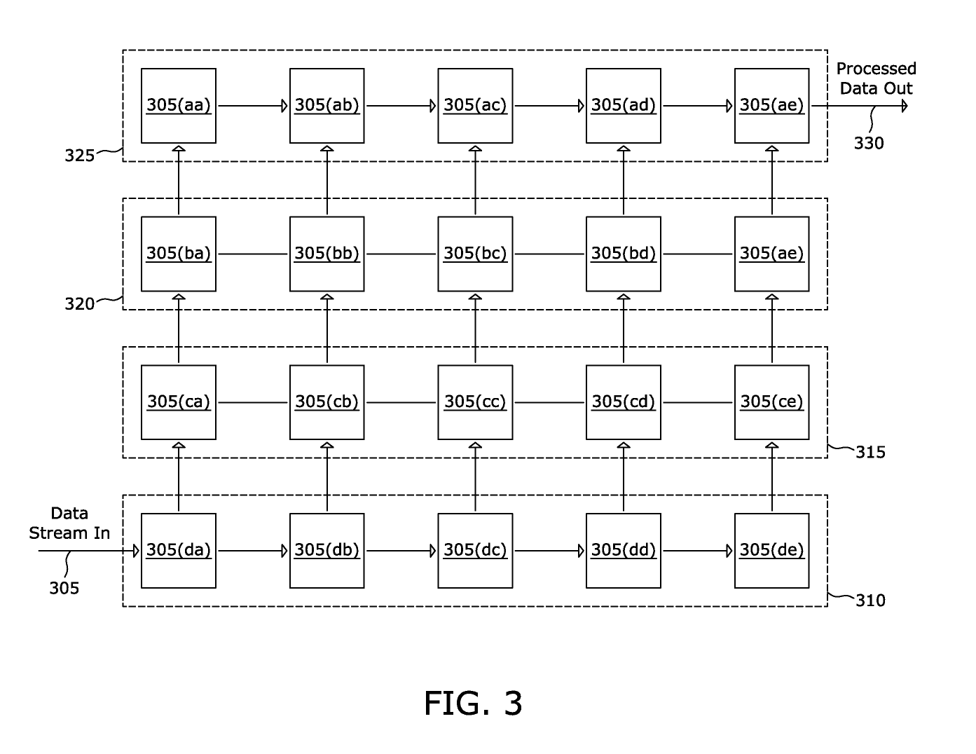

FIG. 3 is an array of processing devices performing high speed data stream split, processing, and reformulation of five samples in parallel according to one embodiment. A data and control path is (herein referred to in short as path) 302 to processing device 305(da). Path 302 represents a serial stream of data coming into the array of processing devices. A first grouping of processing devices 310 includes processing devices 305(da), 305(db), 305(dc), 305(dd), and 305(de) and performs the function of sending every five data sample substream to each of the processing devices as part of grouping 310, as well as sending every five data sample substream to each of the processing devices as part of a second grouping of processing devices 315. Processing device 305(da) receives a first data sample and sends this sample to both processing devices 305(db) and 305(ca). Processing device 305(db) sends the first data sample to both processing devices 305(dc) and 305(cb). Processing device 305(dc) sends the first data sample to both processing devices 305(dd) and 305(cc). Processing device 305(dd) sends the first data sample to both processing devices 305(de) and 305(cd). Processing device 305(de) sends the first data sample to processing device 305(ce). Processing device 305(da) receives a second sample immediately after the first sample, and after the process of sending the first sample to processing devices 305(db), 305(dc), 305(dd), 305(de), and 305(ca), 305(cb), 305(cc), 305(cd), and 305(ce).

The second grouping of processing devices 315 includes processing devices 305(ca), 305(cb), 305(cc), 305(cd), and 305(ce). Each processing device, as part of the grouping 315, receives every five data sample substream. Processing device 305(ca) sends the fifth of every five data sample substream to processing device 305(ba). Processing device 305(cb) sends the fourth of every five data sample substream to processing device 305(bb). Processing device 305(cc) sends the third of every five data sample substream to processing device 305(bc). Processing device 305(cd) sends the second of every five data sample substream to processing device 305(bd). Processing device 305(ce) sends the first of every five data sample substream to processing device 305(be). A third grouping of processing devices 320 includes processing devices 305(ba), 305(bb), 305(bc), 305(bd), and 305(be). Each processing device, as part of this grouping, performs the same function.

The result of the processed data sample in processing device 305(ba) is sent to processing device 305(aa). The result of the processed data sample in processing device 305(bb) is sent to processing device 305(ab). The result of the processed data sample in processing device 305(bc) is sent to processing device 305(ac). The result of the processed data sample in processing device 305(bd) is sent to processing device 305(ad). The result of the processed data sample in processing device 305(be) is sent to processing device 305(ae).

A fourth group of processing devices 325 includes processing devices 305(aa), 305(ab), 305(ac), 305(ad), and 305(ae). The function of grouping 325 is to reformulate the processed data from grouping 320 in the order in which every five data sample substream enter the array of processing devices via path 305. The processed data leaves the array of processing devices via a path 330. Processing device 305(ae) sends to path 330 the first processed data of every five data sample substream. Processing device 305(ad) sends to path 330, via processing device 305(ae), the second processed data of every five data sample substream. Processing device 305(ac) sends to path 330 via processing devices 305(ad) and 305(ae) the third processed data of every five data sample substream. Processing device 305(ab) sends to path 330 via processing devices 305(ac), 305(ad), and 305(ae) the second processed data of every five data sample substream. Processing device 305(aa) sends to path 330 via processing devices 305(ab), 305(ac), 305(ad), and 305(ae).

In an alternate embodiment, path 305 is the movement of data in a stream from another processing device not a part of the high speed data stream split, processing, and reformulation. In this alternate embodiment, path 330 is the movement of processed data to another processing device not a part of the high speed data stream split, processing, and reformulation.

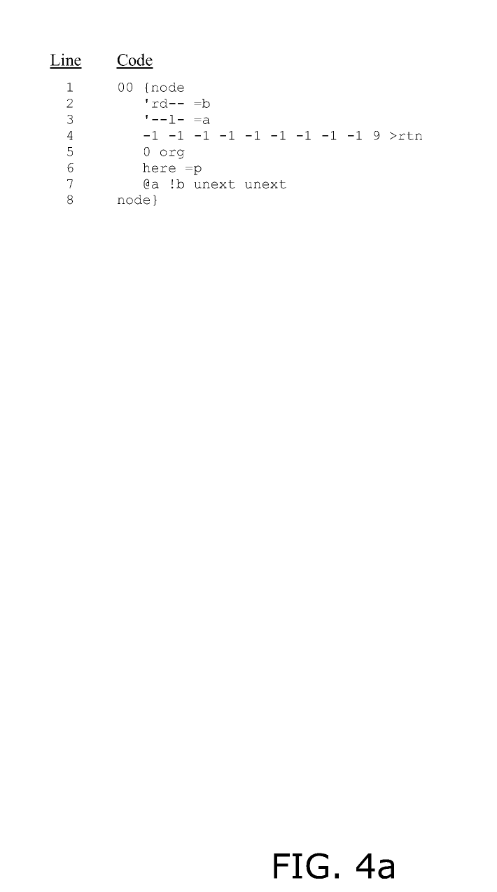

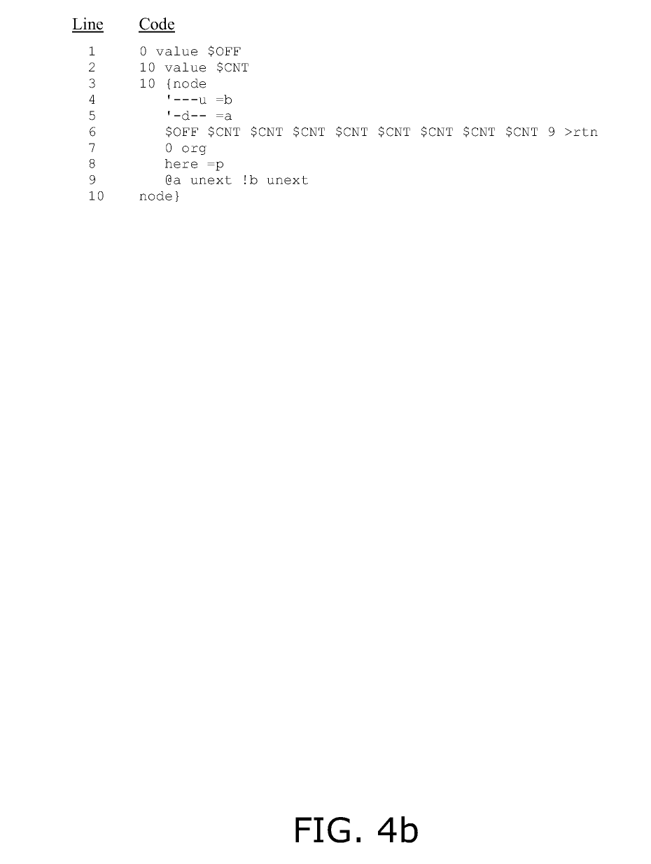

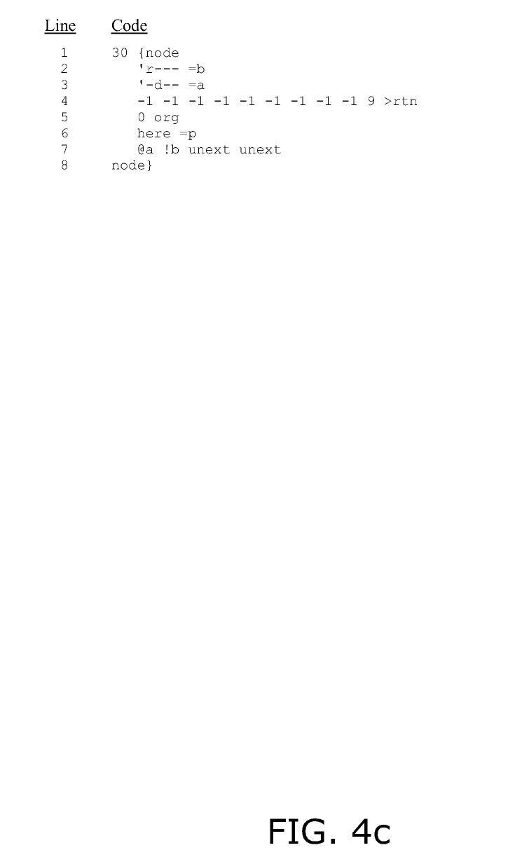

FIG. 4a is the native machine language and compiler directives written to instruct a processing device on the SEAforth® S40 array of processing devices, a preferred embodiment for executing the function of grouping 215 of FIG. 2. Line 1 of FIG. 4a shows the beginning of the definition for processing device 205(ea) of FIG. 2. Line 2 loads the address of the North and East ports corresponding to processing devices 205(da) and 205(eb) into the B-register of processing device 205(ea). Line 3 loads the address of the West port of processing device 205(ea) into the A-register of processing device 205(ea). Both lines 2 and 3 initialize the contents of the A-register and B-register of processing device 205(ea) prior to the execution of any instruction words in processing device 205(ea). The fourth line of FIG. 4a initializes the nine registers of the return stack of processing device 205(ea) to negative one (decimal base). Line 5 of FIG. 4a tells the compiler the location to compile the next operational codes. Line 6 puts the address of $000 in the program counter P-register of processing device 205(ea). The program counter will address the location from which to fetch the first instruction word for execution in processing device 205(ea). Line 7 shows the instruction word which is positioned at the address $00000 of the Random Access Memory (RAM) of processing device 205(ea) and will be discussed in more detail later. Finally, line 8 ends the node definition for processing device 205(ea).

Once processing device 205(ea) receives power, the first instruction word positioned at the address indicated by the program counter at a position $00000 of the RAM will be fetched and positioned into the instruction decode logic of processing device 205(ea). Each of the four instructions, as part of the instruction word, will be executed in the following manner. The @a (pronounced fetch a) instruction will perform a read from the port in which the A-register is addressing. Hence, the execution of the @a instruction will read a data word of the incoming stream of data and place the data word into the T-register of the data stack of processing device 205(ea). The !b (pronounced store b) instruction will perform a write to the address in which the B-register is addressed. Hence, the execution of the !b instruction will write the just received data value in the T-register to the port in which the B-register is addressing. The first unext (pronounced micro next) instruction checks the contents of the R-register of the return stack for zero. If the R-register is zero, then the contents of the R-register are dropped. Due to the fact that the return stack is circular, dropping the contents of the R-register effectively moves the contents of each register below the R-register up one register. The bottom register of the return stack will contain the value of the register just below the R-register prior to the execution of the unext instruction. If the R-register is non-zero, the unext instruction will decrement the R-register by one (decimal base) and return to the beginning of the present instruction word for instruction execution. Hence, the execution of the first unext instruction will result in the execution of the @a and !b instructions a total of 2¹⁸−1 times before the second written unext instruction in line 7 of FIG. 4a is executed. The execution of the second written unext instruction executes 2¹⁸−2 @a and !b instructions before the second execution of the second written unext instruction. Recall that the contents of the R-register, prior to the execution of the second written unext instruction, are −1. Decrementing the contents of the R-register to −2 and returning to the beginning of the instruction words leads to @a and !b being executed followed by the first written unext, which will decrement the contents of the R-register to −3 and return execution to the beginning of the present instruction word. Due to the fact that the R-register never retains a value of zero in any stack register, the instructions @a and !b are indefinitely executed. Also, the first instruction word loaded into the instruction decode logic is the only instruction word ever loaded into the instruction decode logic; there is no delay in pre-fetching the next instruction words. The pre-fetch circuitry is never enabled, and the only delay is in returning to the beginning of the instruction word.

FIG. 4b is the native machine language and compiler directives written to instruct a processing device on the SEAforth® S40 array of processing devices, a preferred embodiment for executing function 220 of FIG. 2. Line 1 of FIG. 4b declares a global constant value $OFF as zero (decimal base). Line 2 of FIG. 4b declares a global constant value $CNT as ten (decimal base). Either of these two global constant value names can be applied through the node definition to take the place of a literal value. Line 3 of FIG. 4b shows the beginning of the definition for processing device 205(da). Line 4 loads the address of the North port corresponding to processing device 205(ca) into the B-register of processing device 205(da). Line 5 loads the address of the South port of processing device 205(da) into the A-register of processing device 205(da). The sixth line of FIG. 4b initializes the nine registers of the return stack of processing device 205(da). The value of zero (decimal base) is placed into the R-register and the value ten (decimal base) is placed into each of the remaining eight registers below the R-register as part of the return stack. Line 7 of FIG. 4b tells the compiler the location to compile the next operational codes. Line 8 of FIG. 4b puts the address of $000 in the program counter P-register of processing device 205(da). The program counter will address the location from which to fetch the first instruction word for execution in processing device 205(da). Line 9 shows the instruction word which is positioned at the address $00000 of the RAM of processing device 205(da), and will be discussed in more detail below. Finally, line 10 ends the definition for processing device 205(da).

Once processing device 205(da) receives power, the first instruction word positioned at the address indicated by the program counter at a position $00000 of the RAM will be fetched and positioned into the instruction decode logic of processing device 205(da). The @a instruction will read a word from processing device 205(ea) and place the data word into the T-register of the data stack of processing device 205(da). The unext instruction will check the R-register for zero (decimal base). Due to the fact that the R-register is zero, the !b instruction is executed, which sends the data word in the T-register to processing device 205(ca). The value in the R-register is dropped and now contains the value of ten (decimal base). The second written unext instruction checks the R-register for zero, and because the value of the R-register is ten (decimal base) the R-register is decremented and execution returns to the beginning of the present instruction word. A total of nine data words are fetched from processing device 205(ea) by the @a instruction in conjunction with the first written unext instruction until the R-register contains zero, in which case the !b instruction will send the tenth data word received into processing device 205(da) to processing device 205(ca). The execution of the second written unext instruction, in which case each register of the return stack contains a value of ten (decimal base) and thus, execution returns to the beginning of the present instruction word where ten more data words are fetched from processing device 205(ea) and only the tenth data word is sent to processing device 205(ca). This sequence of fetching ten data words from processing device 205(ea) and only sending the tenth data word to processing device 205(ca) is indefinitely repeated. There is no memory overload in processing device 205(da) because the fetched data words from processing device 205(ea) are stored in the T-register of the data stack of processing device 205(da). The data stack is circular, so only the data words which are not sent to processing device 205(ca) are eventually overwritten. Also, the first instruction word loaded into the instruction decode logic is the only instruction word ever loaded into the instruction decode logic, there is no delay in pre-fetching the next instruction words. The pre-fetch circuitry is never enabled, and the only delay is in returning to the beginning of the instruction word.

FIG. 4c is the native machine language and compiler directives written to instruct a processing device on the SEAforth® S40 array of processing devices, a preferred embodiment for executing function 230 of FIG. 2. Line 1 of FIG. 4c shows the beginning of the definition for processing device 205(ea) of FIG. 2. Line 2 loads the address of the South port corresponding to processing device 205(ba) into the B-register of processing device 205(aa). Line 3 loads the address of the East port of processing device 205(aa). Both lines 2 and 3 initialize the contents of the A-register and B-register of processing device 205(aa) prior to the execution of any instruction words in processing device 205(aa). The fourth line of FIG. 4c initializes the nine registers of the return stack of processing device 205(aa) to negative one (decimal base). Line 5 of FIG. 4c puts the address of $000 in the program counter P-register of processing device 205(aa). The program counter will address the location from which to fetch the first instruction word for execution in processing device 205(aa). Line 7 shows the instruction word which is positioned at the address $00000 of the Random Access Memory (RAM) of processing device 205(aa), and will be discussed in more detail later. Finally, line 8 ends the definition for processing device 205(aa).

Once processing device 205(aa) receives power, the first instruction word positioned at the address indicated by the program counter at a position $00000 of the RAM will be fetched and positioned into the instruction decode logic of processing device 205(aa). Each of the four instructions, as part of the instruction word, will be executed in the following manner. The @a instruction will perform a read from the port in which the A-register is addressing. Hence, the execution of the @a instruction will read a processed data word from processing device 205(ba) and place the processed data word into the T-register of the data stack of processing device 205(aa). The !b instruction will perform a write to the address in the B-register. Hence, the execution of the !b instruction will write the just received processed data value in the T-register to the port in which the B-register is addressing. The first unext instruction checks the contents of the R-register of the return stack for zero. If the R-register is zero, then the contents of the R-register are dropped. Due to the fact that the return stack is circular, dropping the contents of the R-register effectively moves the contents of each register below the R-register up one register. The bottom register of the return stack will contain the value of the register just below the R-register prior to the execution of the unext instruction. If the R-register is non zero, the unext instruction will decrement the R-register by one (decimal base) and return to the beginning of the present instruction word for instruction execution. Hence, the execution of the first unext instruction will result in the execution of the @a and !b instructions a total of 2¹⁸−1 times before the second written unext instruction in line 7 of FIG. 4c is executed. The execution of the second written unext instruction will decrement the R-register by one (decimal base) and return to the beginning of the present instruction word for instruction execution. Hence, the execution of the second written unext instruction executes 2¹⁸−2 @a and !b instructions before the second execution of the second written unext instruction. Recall that the contents of the R-register prior to the execution of the second written unext instruction are −1. Decrementing the contents of the R-register to −2 and returning to the beginning of the instruction words leads to @a and !b being executed following the beginning of the instruction word which leads to @a and !b being executed followed by the first written unext, which will decrement the contents of the R-register to −3 and return execution to the beginning of the present instruction word. Due to the fact that the R-register never retains a value of zero in any stack register, the instructions @a and !b are indefinitely executed. Also, the first instruction word loaded into the instruction decode logic is the only instruction word ever loaded into the instruction decode logic, there is no delay in pre-fetching the next instruction words. The pre-fetch circuitry is never enabled, and the only delay is in returning to the beginning of the instruction word.

### INDUSTRIAL APPLICABILITY

The inventive computer logic arrays processors 205, busses 110, 210, groupings 220, 225 and 235, and signal processing methods are intended to be widely used in a great variety of communication applications, including hearing aid systems. It is expected that they will be particularly useful in wireless applications where significant computing power and speed is required.

As discussed previously herein, the applicability of the present invention is such that the inputting information and instructions are greatly enhanced, both in speed and versatility. Also, communications between a computer array and other devices are enhanced according to the described method and means. Since the inventive computer logic arrays processors 205, busses 110, 210, groupings 220, 225 and 235, and signal processing methods may be readily produced and integrated with existing tasks, input/output devices and the like, and since the advantages as described herein are provided, it is expected that they will be readily accepted in the industry. For these and other reasons, it is expected that the utility and industrial applicability of the invention will be both significant in scope and long-lasting in duration.

1) An apparatus for performing high speed data stream splitting, processing, and reformulation comprising: an array of processors connected to one another by single drop buses; wherein a first group of processors in said array are for data stream splitting; and a second group of processors in said array are for data stream processing; and a third group of processors in said array are for data stream reformulation.

2) An apparatus for performing high speed data stream splitting, processing, and reformulation as in claim 1, wherein once data is split by said first group of processors it is processed in parallel by said second group of processors.

3) An apparatus for performing high speed data stream splitting, processing, and reformulation as in claim 2, wherein once data is processed by said second group of processors, said third group reformulates said processed data into a data stream.

4) An apparatus for performing high speed data stream splitting, processing, and reformulation as in claim 2, wherein the inputs of said first group of processors are in series and the outputs of said first group of processors are connected in parallel to said second group of processors.

5) An apparatus for performing high speed data stream splitting, processing, and reformulation as in claim 4, wherein there is at least one processor in said second group for each split data stream.

6) An apparatus for performing high speed data stream splitting, processing, and reformulation as in claim 4, wherein the inputs of each of the processors in said third group are connected in parallel to the outputs of said second group of processors and there is a single output from said third group of processors.

7) An apparatus for performing high speed data stream splitting, processing, and reformulation as in claim 5, wherein the inputs of each of the processors in said third group are connected in parallel to the outputs of said second group of processors and there is a single output from said third group of processors.

8) An array of processors each having at least one input and at least one output for performing high speed data stream splitting, processing, and reformulation comprising: an input for accepting a stream of data; and a first plurality of processors connected in series to said input for producing a split of said data stream at the output of each individual processor; and a second plurality of processors wherein at least one processor has its input connected to an output of each one of said first processors for processing said split of said data stream; and a third plurality of processors connected to each other in series having one of each processors input connected to a processor in said second plurality for reformulating said splits into a processed data stream; and an output for outputting a reformulated data stream connected to one of said third group of processors.

9) An array of processors as in claim 8, wherein there are at least two processors in said first plurality of processors for each split of said data stream.

10) An array of processors as in claim 8, wherein there are at least two processors in said second plurality of processors for each of said splits of said data stream.

11) A method of processing a high speed data stream comprising the steps of: inputing a stream of data into a processor array, and splitting the data stream into a plurality of substreams, and processing the substreams in parallel, reformulating the substreams into a processed data stream, and outputting the processed data stream.

12) A method of processing a high speed data stream as in claim 11, wherein said processing in parallel step is further comprised of the steps of: a first processing step of each substream, and a second processing step.

13) A method of processing a high speed data stream as in claim 11, further comprising the steps of: allocating 2n processing devices for the separating of data samples wherein the first n processing devices each receive n data samples and the second n processing devices filter the n data samples; and further allocating kn processing devices for the processing of the filtered data samples.

14) A method of processing a high speed data stream as in claim 11, including the further steps of: determining the number of available processors; and splinting the data stream into a number of substreams appropriate for the number of available processors.
